(19) United States
(12) Patent Application Publication
(10) Pub. No.: US 2026/0246580 A1
(43) Pub. Date: Aug. 20, 2026

(54) Method and Apparatus for multiple-Downlink Control Information (mDCI) based Simultaneous Transmission across Multiple Panels (STxMP) in Wireless Communication

(71) Applicant: Apple Inc., Cupertino, CA (US)

(72) Inventors: Seyed Ali Akbar Fakoorian, San Diego, CA (US); Ankit Bhamri, Haar (DE); Chunxuan Ye, San Diego, CA (US); Dawei Zhang, Saratoga, CA (US); Haitong Sun, Saratoga, CA (US); Hong He, San Jose, CA (US); Wei Zeng, Saratoga, CA (US)

(21) Appl. No.: 19/472,330

(22) PCT Filed: Apr. 3, 2024
(86) PCT No.: PCT/US2024/022799

§ 371 Date: Oct. 3, 2025

Related U.S. Application Data
(60) Provisional application No. 63/494,669, filed on Apr. 6, 2023.

(51) Int. Cl. H04L 5/00; H04L 27/26

(52) U.S. Cl. CPC H04L 5/0044; H04L 27/261

(57) ABSTRACT

Methods, systems, and devices for multiple-Downlink Control Information (mDCI) based Simultaneous Transmission across Multiple Panels (STxMP) in Wireless Communications are described.

### FIELD

The present application relates to wireless devices and wireless networks, including systems, devices, circuits, and methods for multiple-Downlink Control Information (mDCI) based Simultaneous Transmission across Multiple Panels (STxMP) in Wireless Communication.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHIRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

Currently under study is simultaneous multi-panel (STxMP) uplink (UL) transmission from a communication device in communication with a network. Such studies must be coordinated with current multi-transmission/reception points (mTRP) protocols in order to successfully increase the UL throughput and maintain reliability. In such protocols, the Downlink Control Information (DCI) transmitted to the communication device may be received using a Physical Downlink Shared Channel (PDSCH) on multiple carriers with a single DCI on a Downlink Control Channel (PDCCH) (i.e., sDCI). Alternatively, the PDSCH on multiple carriers may be scheduled using multiple DCIs on PDCCHs on multiple carriers (i.e., mDCI).

However, in the uplink, the total number of layers available for transmission across all antenna ports on a given UE is up to four across all antenna panels, and the total number of codewords is up to two across all panels in mTRP operation. Accordingly, there is a need to establish mDCI, mTRP communication considering the maximum number of layers available when separate overlapping Physical Uplink Shared Channels (PUSCHs) are scheduled. Furthermore, the Sounding Reference Signal (SRS) resource indicator (SRI)/Transmit Precoder Matrix Indicator (TPMI) bit-fields of a DCI message depend on the maximum number of layers, the number of SRS resources, and the number of SRS antenna ports associated to each SRS resource set. How such considerations, as well as power adjustment considerations for mDCI based PUSCH+PUSCH transmissions, have yet to be established in mDCI mTRP communication. Also, switching between a sDCI based spatial domain-division multiplexing/single-frequency network (SDM/SFN) to a mDCI based PUSCH+PUSCH is currently not allowed.

Given the various deficiencies described above, there is a need to establish additional features for mDCI-based STxMP, e.g., to increase the UL throughput, while maintaining efficiency and reliability of the network.

### SUMMARY

In one aspect, embodiments relate to a method for mDCI STxMP transmissions that includes the UE transmitting in a UE capability message at least one maximum number of layers associated with the panels of the UE. The UE receives a first DCI including a first CORESET pool index from a first TRP, and the UE receives a second DCI comprising a second CORESET pool index from a second TRP. The maximum number of layers associated with panels of the UE may include a value for single TRP transmission and at least one value for multiple TRP transmissions.

In another aspect, embodiments relate to a method for mDCI STxMP transmissions that includes the UE transmitting, in a UE capability message, a maximum number of layers for each panel of the UE. The UE receives a first DCI including a first CORESET pool index from a first TRP, and the UE receives a second DCI comprising a second CORESET pool index from a second TRP. The method includes the UE determining that the indicated ranks for overlapping PUSCHs from the first DCI and the second DCI violate the maximum number of layers for at least one of the panel of the UE. Various steps may then be taken to alleviate the violation.

In another aspect, embodiments relate to a method of switching between single PUSCH STxMP and multiple PUSCH STxMP transmissions. The method includes determining that a UE is configured with two SRS resource sets with the same usage. The UE is Radio Resource Control (RRC) configured for single PUSCH STxMP and multiple PUSCH STxMP transmissions. The method further includes transmitting using multiple PUSCH STxMP transmissions when the UE receives a first DCI including a first CORESET pool index and a second DCI including a second CORESET pool index when the first CORESET pool index is different from the second CORSET pool index. The method includes transmitting using single PUSCH STxMP transmissions when the UE has not received the first DCI and the second DCI, and the UE is scheduled a non-overlapping PUSCH.

In another aspect, embodiments relate to a method of for mDCI STxMP transmissions that includes the UE receiving a first DCI including a first CORESET pool index from a first TRP, and receiving a second DCI comprising a second CORESET pool index from a second TRP. The UE is configured with two Sounding Reference Signal (SRS) resource sets with the same usage. The method includes determining that the UE is scheduled a PUSCH that does not overlap with another PUSCH. If the UE is configured for single PUSCH STxMP transmissions, the method transmits using single PUSCH STxMP based transmission based on an SRS resource set indicator. If the UE is not configured for single PUSCH STxMP transmissions, the method transmits using single PUSCH STxMP based transmission based on an SRS resource set based on an SRS resource set associated with the first or second CORESET pool index.

In another aspect, embodiments relate to a method for mDCI STxMP transmissions that includes the UE receiving a first DCI including a first CORESET pool index from a first TRP and receiving a second DCI including a second CORESET pool index from a second TRP. The UE is configured with two Sounding Reference Signal (SRS) resource sets with the same usage. In codebook based embodiments, the two resource sets may have a different number of SRS antenna ports. In non-codebook based embodiments, the two resource sets may have a different number of SRS resources.

In another aspect, embodiments relate to a method for power adjustment in mDCI STxMP transmissions that includes the UE transmitting in a UE capability message, a capability of a single power amplification for all panels of the UE. The UE receives a first DCI including a first CORESET pool index from a first TRP, and receives a second DCI comprising a second CORESET pool index from a second TRP. The method includes the UE determining a first transmission power for a first PUSCH and a second transmission power for a second PUSCH. When the sum of the first transmission power and the second transmission power is greater than a total maximum power constraint across all panels, the first PUSCH is dropped and the second PUSCH is transmitted using the second transmission power.

In another aspect, embodiments relate to a method for power adjustment in mDCI STxMP transmissions that includes the UE transmitting in a UE capability message, a capability of separate power amplifications for each panel of the UE and inter-panel dynamic power sharing. The UE receives a first DCI including a first CORESET pool index from a first TRP, and receives a second DCI comprising a second CORESET pool index from a second TRP. The method includes the UE determining a reference PUSCH and a non-reference PUSCH from among the first PUSCH and second PUSCH established from the first DCI and second DCI, respectively. A reference transmission power is determined for the reference PUSCH. A second transmission power is determined for the non-reference PUSCH by taking the minimum of a maximum transmit power for the non-reference PUSCH and the subtraction of the reference transmission power from a total maximum power. The reference PUSCH and the non-reference PUSCH are transmitted at the reference transmission power and second transmission power, respectively.

In another aspect, embodiments relate to a method of carrier aggregation that include prioritizing STxMP transmissions in a first component carrier of a cell group over non-STxMP transmissions in a second component carrier of the cell group.

In another aspect, embodiments relate to a method for mDCI STxMP transmissions that includes the UE receiving a first DCI including a first CORESET pool index from a first TRP at a first time, and receiving a second DCI comprising a second CORESET pool index from a second TRP at a second time, The second time is after the first time. The method includes transmitting a first PUSCH based on the first DCI before transmitting a second PUSCH based on the second DCI. The first DCI and the second DCI indicate a same closed loop index, and Transmit Power Control (TPC) accumulation is disabled. These embodiments establish that no out of order PUSCHs are allowed.

In another aspect, embodiments relate to a method for mDCI STxMP transmissions that includes the UE receiving a first DCI including a first CORESET pool index from a first TRP. The the first DCI establishing a first Physical Uplink Shared Channel (PUSCH). The UE receives a second DCI comprising a second CORESET pool index from a second TRP establishing a second PUSCH. A reference PUSCH is determined from the first PUSCH and the second PUSCH. Then, a time period is determined between a last symbol transmission of the first DCI and the second DCI and a first symbol of the reference PUSCH. The method includes transmitting the reference PUSCH at the conclusion of the time period, and transmitting the remaining PUSCH of the first PUSCH and second PUSCH. In embodiments, the time period includes a number of symbols based on the UE's capabilities that contribute to the time period.

The techniques described herein may be implemented in and/or used with a number of different types of devices, including but not limited to cellular phones, wireless devices, tablet computers, wearable computing devices, portable media players, Internet of Things (IoT) devices, vehicles, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates a communication device, according to some aspects.

FIG. 3 illustrates an example block diagram of a Base Station (BS), according to some aspects.

FIG. 4 illustrates communication in a system, in accordance with some aspects.

FIGS. 5A and 5B are schematics illustrating a processing timeline for PUSCH+PUSCH transmissions, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

In general, embodiments disclosed herein are directed to simultaneous multi-panel UL transmissions from a UE for higher UL throughput and reliability. For explanation purposes, embodiments assume two TRPs and two panels per UE, but some embodiments may not be limited as such. The total number of layers is assumed to be up to four layers across all panels, and the total number of codewords is up to two across all panels for single DCI (sDCI) and multiple DCI (mDCI) based mTRP operation. Embodiments disclosed herein have the advantage of not requiring a new codebook for multi-panel simultaneous transmission.

Currently, for mDCI based STxMP, to schedule PUSCH+PUSCH transmission, a first SRS resource set is associated with coresetPoolIndex value 0 and the other SRS resource set is associated with coresetPoolIndex value 1. That is, the PUSCH is associated with the SRS resource set with the same value of coresetPoolIndex.

The SRI/TPMI field in a DCI message is interpreted depending on the type of the PUSCH. For example, for a dynamic grant (DG)-PUSCH, the indicated SRI/TPMI field corresponds to the SRS resource set associated with same coresetPoolIndex value of the CORESET when scheduling DCI format 0_1 or 0_2 is received. The same is true for Type 2 configured grant (CG)-PUSCH, where the field is included in the activation DCI. For Type 1 CG-PUSCH, one SRS resource set index value (i.e., SRS_resource_set_index) is configured in Radio Resource Control (RRC) message (e.g., ConfiguredGrantConfig). Other variables correspond to the SRS resource set (e.g., srs-ResourceIndicator/precodingAndNumberOfLayers).

Embodiments disclosed herein establish mDCI, mTRP communication considering the maximum number of layers when separate overlapping Physical Uplink Shared Channels (PUSCHs) are scheduled. In an ideal backhaul between the TRPs, the number of layers associated to each panel (or SRS resource set) may be maintained within the UE capabilities. However, in a non-ideal backhaul, the number of layers associated to each panel may violate the UE capabilities. As will be explained below, embodiments disclosed herein address these deficiencies by defining a new UE capability for PUSCH+PUSCH transmissions.

Also, switching between a sDCI based spatial domain-division multiplexing/single-frequency network (SDM/SFN) to a mDCI based PUSCH+PUSCH is, in general, not currently allowed. Embodiments disclosed herein provide solutions to avoid such switching.

Furthermore, the Sounding Reference Signal (SRS) resource indicator (SRI)/Transmit Precoder Matrix Indicator (TPMI) bit-fields of a DCI message depend on the maximum number of layers, the number of SRS resources, and the number of SRS antenna ports associated to each SRS resource set. Embodiments disclosed herein establish such considerations in mDCI, mTRP communication.

Embodiments are further directed to power amplification considerations for mDCI based PUSCH+PUSCH transmissions. Embodiments establish a mechanism to determine a transmit power for fully and partially overlapping PUSCHs. Embodiments further define a timeline based on the transmit power that is determined and applied to PUSCHs. The time line may be applied for DG-PUSCH+DG-PUSCH and CG-PUSCH+DG-PUSCH transmissions. The timeline may also be used to switch between sTRP to mTRP, and transmit power determinations.

The following is a glossary of additional terms that may be used in this disclosure:

Memory Medium—Any of various types of non-transitory memory devices or storage devices. The term “memory medium” is intended to include an installation medium, (e.g., a CD-ROM, floppy disks, or tape device; a computer system memory or random-access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, PlayStation Vita™, PlayStation Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.

Wireless Device—any of various types of computer systems or devices that perform wireless communications. A wireless device may be portable (or mobile) or may be stationary or fixed at a certain location. A UE is an example of a wireless device.

Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

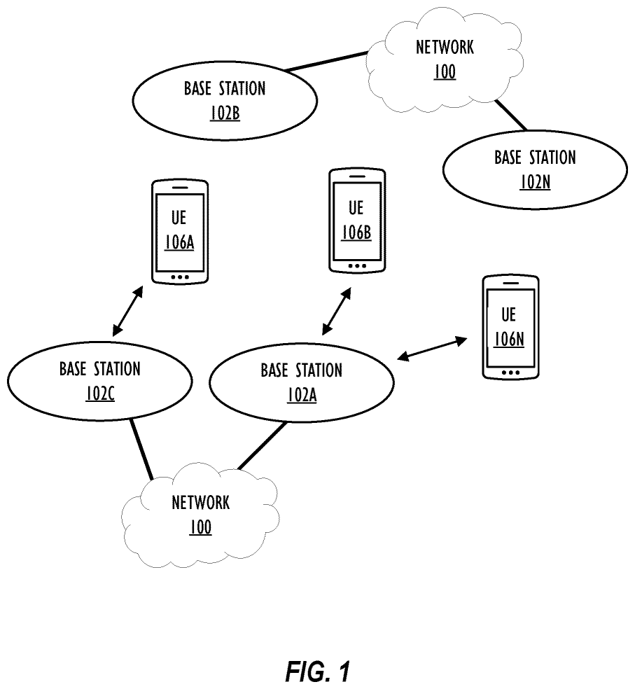

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106N. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using a side link (SL) interface for direct communications between devices. The IoT UEs may also execute background applications (e.g., keep-alive messages, status updates, and the like) to facilitate the connections of the IoT network.

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high-speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weather enclosure suitable for outdoor installation, and it may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each UE 106 may also be capable of receiving signals from (and possibly within communication range of) one or more other cells (which may be provided by base stations 102B-102N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102N may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more TRPs. In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-N/H), and/or any other wireless communication protocol, if desired. Other combinations of wireless communication standards (including more than two wireless communication standards) are also possible.

In one or more embodiments, the UE 106 may be a device with cellular communication capability such as a mobile phone, a hand-held device, a computer, a laptop, a tablet, a smart watch, or other wearable device, or virtually any type of wireless device. Embodiments may also include vehicles, industrial equipment, or other devices that may benefit from multi-panel wireless connectivity.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1×RTT/1×EV-DO/HRPD/eHIRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a BB processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Example Communication Device

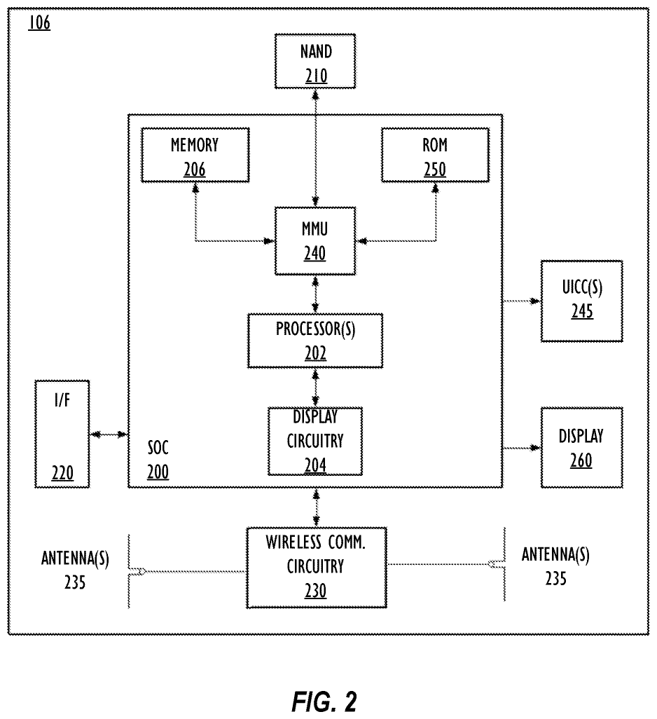

FIG. 2 illustrates an example simplified block diagram of a communication device 106, according to some aspects. It is noted that the block diagram of the communication device of FIG. 2 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 200 configured to perform core functions. For example, this set of components may be implemented as a system on chip (SOC), which may include portions for various purposes. Alternatively, this set of components 200 may be implemented as separate components or groups of components for the various purposes. The set of components 200 may be coupled (e.g., communicatively; directly or indirectly) to various other circuits of the communication device 106.

For example, the communication device 106 may include various types of memory (e.g., including NAND flash 210), an input/output interface such as connector I/F 220 (e.g., for connecting to a computer system; dock; charging station; input devices, such as a microphone, camera, keyboard; output devices, such as speakers; and the like), the display 260, which may be integrated with or external to the communication device 106, and wireless communication circuitry 230 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 230 may couple (e.g., communicatively; directly or indirectly) to one or more antennas, such as antenna(s) 235 as shown. The wireless communication circuitry 230 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 230 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 230 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements. The communication device 106 may further include one or more smart cards 245 that include Subscriber Identity Module (SIM) functionality, such as one or more Universal Integrated Circuit Card(s) (UICC(s)) cards 245.

As shown, the SOC 200 may include processor(s) 202, which may execute program instructions for the communication device 106 and display circuitry 204, which may perform graphics processing and provide display signals to the display 260. The processor(s) 202 may also be coupled to memory management unit (MMU) 240, which may be configured to receive addresses from the processor(s) 202 and translate those addresses to locations in memory (e.g., memory 206, read only memory (ROM) 250, NAND flash memory 210) and/or to other circuits or devices, such as the display circuitry 204, wireless communication circuitry 230, connector I/F 220, and/or display 260. The MMU 240 may be configured to perform memory protection and page table translation or set up. In some aspects, the MMU 240 may be included as a portion of the processor(s) 202.

As noted above, the communication device 106 may be configured to communicate using wireless and/or wired communication circuitry. As described herein, the communication device 106 may include hardware and software components for implementing any of the various features and techniques described herein. The processor 202 of the communication device 106 may be configured to implement part or all of the features described herein (e.g., by executing program instructions stored on a memory medium). Alternatively (or in addition), processor 202 may be configured as a programmable hardware element, such as a Field Programmable Gate Array (FPGA), or as an Application Specific Integrated Circuit (ASIC). Alternatively (or in addition) the processor 202 of the communication device 106, in conjunction with one or more of the other components 200, 204, 206, 210, 220, 230, 240, 245, 250, 260 may be configured to implement part or all of the features described herein.

In addition, as described herein, processor 202 may include one or more processing elements. Thus, processor 202 may include one or more integrated circuits (ICs) that are configured to perform the functions of processor 202. In addition, each integrated circuit may include circuitry (e.g., first circuitry, second circuitry, and the like) configured to perform the functions of processor(s) 202.

Further, as described herein, wireless communication circuitry 230 may include one or more processing elements. In other words, one or more processing elements may be included in wireless communication circuitry 230. Thus, wireless communication circuitry 230 may include one or more integrated circuits (ICs) that are configured to perform the functions of wireless communication circuitry 230. In addition, each integrated circuit may include circuitry (e.g., first circuitry, second circuitry, and the like) configured to perform the functions of wireless communication circuitry 230.

### Example Base Station

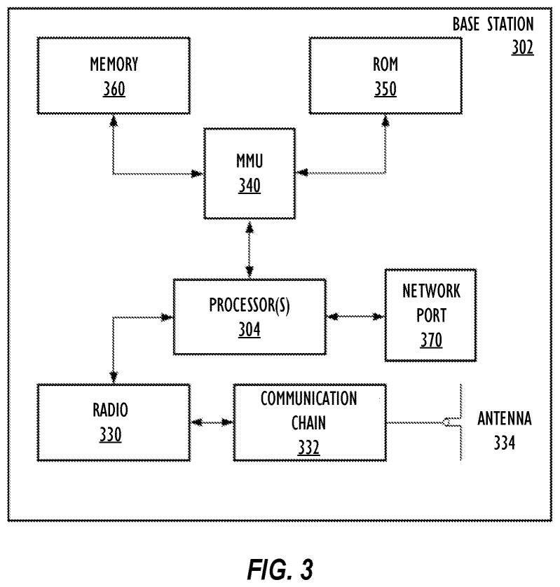

FIG. 3 illustrates an example block diagram of a base station 302, according to some aspects. It is noted that the base station of FIG. 3 is a non-limiting example of a possible base station. As shown, the base station 302 may include processor(s) 304 which may execute program instructions for the base station 302. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The base station 302 may include at least one network port 370. The network port 370 may be configured to couple to a telephone network and provide a plurality of devices, such as UE devices 106, access to the telephone network as described above in FIG. 1.

The network port 370 (or an additional network port) may also or alternatively be configured to couple to a cellular network, e.g., a core network of a cellular service provider. The core network may provide mobility related services and/or other services to a plurality of devices, such as UE devices 106. In some cases, the network port 370 may couple to a telephone network via the core network, and/or the core network may provide a telephone network (e.g., among other UE devices serviced by the cellular service provider).

In some aspects, base station 302 may be a next generation base station, (e.g., a 5G New Radio (5G NR) base station, or “gNB”). In such aspects, base station 302 may be connected to a legacy evolved packet core (EPC) network and/or to a NR core (NRC)/5G core (5GC) network. In addition, base station 302 may be considered a 5G NR cell and may include one or more transition and reception points (TRPs). In addition, a UE capable of operating according to 5G NR may be connected to one or more TRPs within one or more gNBs.

The base station 302 may include at least one antenna 334, and possibly multiple antennas. The at least one antenna 334 may be configured to operate as a wireless transceiver and may be further configured to communicate with UE devices 106 via radio 330. The antenna 334 communicates with the radio 330 via communication chain 332. Communication chain 332 may be a receive chain, a transmit chain or both. The radio 330 may be configured to communicate via various wireless communication standards, including 5G NR, LTE, LTE-A, GSM, UMTS, CDMA2000, Wi-Fi, and the like.

The base station 302 may be configured to communicate wirelessly using multiple wireless communication standards. In some instances, the base station 302 may include multiple radios, which may enable the base station 302 to communicate according to multiple wireless communication technologies. For example, as one possibility, the base station 302 may include an LTE radio for performing communication according to LTE as well as a 5G NR radio for performing communication according to 5G NR. In such a case, the base station 302 may be capable of operating as both an LTE base station and a 5G NR base station. When the base station 302 supports mmWave, the 5G NR radio may be coupled to one or more mmWave antenna arrays or panels. As another possibility, the base station 302 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 302 may include hardware and software components for implementing or supporting implementation of features described herein. The processor 304 of the base station 302 may be configured to implement or support implementation of part or all of the methods described herein (e.g., by executing program instructions stored on a memory medium). Alternatively, the processor 304 may be configured as a programmable hardware element, such as a Field Programmable Gate Array (FPGA), or as an Application Specific Integrated Circuit (ASIC), or a combination thereof. Alternatively (or in addition) the processor 304 of the BS 302, in conjunction with one or more of the other components 330, 332, 334, 340, 350, 360, 370 may be configured to implement or support implementation of part or all of the features described herein.

In addition, as described herein, processor(s) 304 may include one or more processing elements. Thus, processor(s) 304 may include one or more integrated circuits (ICs) that are configured to perform the functions of processor(s) 304. In addition, each integrated circuit may include circuitry (e.g., first circuitry, second circuitry, and the like) configured to perform the functions of processor(s) 304.

Further, as described herein, radio 330 may include one or more processing elements. Thus, radio 330 may include one or more integrated circuits (ICs) that are configured to perform the functions of radio 330. In addition, each integrated circuit may include circuitry (e.g., first circuitry, second circuitry, and the like) configured to perform the functions of radio 330.

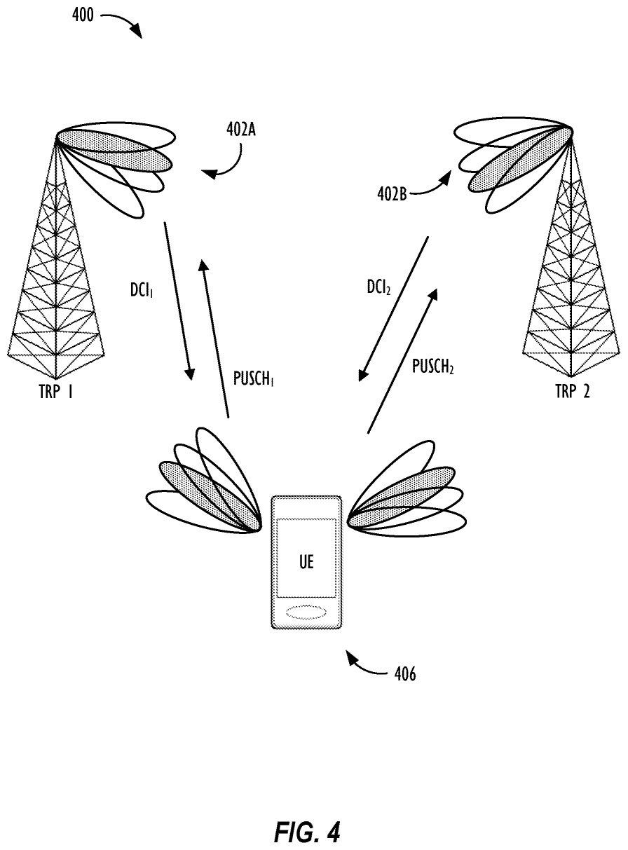

FIG. 4 illustrates an example simplified system, according to some aspects. The system 400 illustrates mDCI, mTRP, STxMP, PUSCH+PUSCH communication between TRP 1 402A and a UE 406 and TRP 2 402B and the UE 406. The UE 406 is illustrated with a panel on each side, each panel with one or more transceivers that may be capable beam forming in accordance with current beamforming and MIMO techniques.

In embodiments disclosed herein, TRP 1 402A transmits DCI₁ to the UE 406, while TRP 2 402B transmits DCI₂ to another panel of the UE 406. DCI₁ and DCI₂ are used to generate PUSCH₁ and PUSCH₂, respectively. PUSCH₁ and PUSCH₂ may then be independently transmitted to TRP 1 402A and TRP 2 402B, respectively.

One of ordinary skill in the art will appreciate that embodiments are not only related to mDCI, STxMP, PUSCH+PUSCH transmissions, but also related to a UE receiving a single DCI from one or more TRPs and transmitting PUSCH+PUSCH to separate TRPs (i.e., sDCI, STxMP, PUSCH+PUSCH) and single DCI from a single TRP and transmitting a PUSCH using STxMP. Embodiments disclosed herein address the overall management of a system, while taking the different modes of transmissions into consideration.

In embodiments disclosed herein, the UE may indicate as part of a UE capability message, a separate maximum number of layers associated to each panel/SRS resource set. The separate maximum number of layers may include one number for sTRP based transmissions and another value if UE is indicated for mTRP based overlapping PUSCHs. For example, the maximum number of layers indicated in the UE capability could be (4, 2+1). In this example, the maximum number of layers (4) may be used for sTRP transmissions. The maximum number of layers for sTRP based transmission may be same as the legacy value (e.g., Lmax). That is, the maximum number of layers for sTRP is not defined per panel/SRS resource set. In the example, for mTRP based overlapping PUSCHs, the maximum number of layers would be 2 for the first SRS resource set and 1 for the second SRS resource set if the PUSCHs overlap.

In some embodiments, the maximum number of layers for mTRP based overlapping PUSCHs may be indicated per panel/SRS resource set, or a value common to both panels may be indicated. This per panel maximum number of layers for overlapping PUSCHs may be the same or different than that of sDCI based SDM scheme.

In embodiments disclosed herein, the UE may define separate capabilities on the maximum number of layers for overlapping PUSCHs, such as {2+2} or {1+1}, depending on whether the overlapping PUSCHs are fully overlapping or partially overlapping in time, overlapping in time and in frequency, and whether DMRS symbols are aligned or not.

The UE may determine there is mDCI communication based on the received DCIs. For example, if the DCIs are different. More specifically, a first CORESET pool index in a first DCI received may be detected as different from the second CORESET pool index in a second DCI received.

In this context, the backhaul refers to the signal between the 5G core and remote sites or networks. Ideal backhaul is when there are 2 TRPs that are completely synchronous with their scheduling. When there is non-ideal backhaul, the synchronous scheduling may be broken, i.e., when one TRP is scheduling the UE, it is not necessarily considering the scheduling at the other TRP.

In an ideal backhaul, it is likely that the indicated ranks in a DCI will not violate the UE capabilities. However, in an non-ideal backhaul, it is possible that if UE is indicated for mTRP based overlapping PUSCHs, the indicated rank violates UE capability for mTRP based overlapping PUSCHs.

For example, the UE capability may indicate {2+2}, but the indicated ranks for two overlapping PUSCHs may be {3+1}. Embodiments disclosed herein provide methods for addressing such violations.

In some embodiments, the PUSCH that carries higher priority data (e.g., ultra-reliable low latency communications (URLLC)) is transmitted, and the lower priority PUSCH is dropped. This may operate similarly to intra-UE PUSCH cancellation in sTRP transmissions. In such embodiments, a cancellation timeline must be defined and satisfied for cancelling the low priority PUSCH. That is, the time between the last symbol of the DCI scheduling high priority PUSCH and the first symbol of the low priority PUSCH shall not be less than Tproc,2 for fully cancellation.

As a second alternative, if one of the PUSCH is a DG-PUSCH and the other PUSCH is a CG-PUSCH, the CG-PUSCH is dropped. This alternative may follow a determination that the DG-PUSCH and CG-PUSCH have the same priority.

If both PUSCHs are DG-PUSCHs, the PUSCH that starts earlier will transmitted, and the other PUSCH is dropped. If both PUSCHs start at the same time, the PUSCH corresponding to the DCI that ends earlier will be transmitted.

Any combination or order of the actions for selecting one of the PUSCHs above may be implemented. For example, the UE may determine if one PUSCH has a higher priority. If the PUSCHs have the same priority, the UE may determine if one of the PUSCH is a CG-PUSCH. If not, and the PUSCHs are DG-PUSCHs, the UE may compare the starting times of the associated DCIs. If the DCIs start at the same time, the UE may compare the ending times of the associated DCIs. If, by chance, after the above determinations a PUSCH for transmission has not be selected (or prioritized), the UE may just randomly pick one of the PUSCHs.

As noted above, switching between a sDCI based SDM/SFN to a mDCI based PUSCH+PUSCH is not currently allowed. STxMP transmissions of two independent PUSCHs (i.e., PUSCH+PUSCH) when the UE is configured with two SRS resource sets with the same usage is allowed if the UE is configured by higher layer parameter PDCCH-Config that contains two different values of coresetPoolIndex in ControlResourceSet. The UE may expect to receive multiple PDCCHs scheduling full or partially-overlapped PUSCHs in time and possibly frequency domain only when PDCCHs that schedule two PUSCHs are associated to different ControlResourceSets having different values of coresetPoolIndex. Further, STxMP transmissions of a single PUSCH configured as SDM (or SFN) is allowed if UE is configured with two SRS resource sets with the same usage.

In accordance with embodiments disclosed herein, when the UE is configured with two SRS resource sets with the same usage, switching between single PUSCH STxMP (with SDM or SFN) and PUSCH+PUSCH STxMP may be allowed under certain conditions. Specifically, the UE must be RRC configured with SDM (or SFN), as well as RRC configured with coresetPoolIndex in ControlResourceSet. If the UE detects two DCIs associated to different ControlResourceSets having different values of coresetPoolIndex, the UE may assume PUSCH+PUSCH transmissions, and the UE interprets each DCI with single SRI/TPMI bit field, where the size of fields are associated to the corresponding SRS resource set. Otherwise, if the UE is scheduled a single PUSCH non-overlapping with another PUSCH, the UE may assume STxMP transmissions configured for SDM (or SFN). In these embodiments, as will be explained further below, a timeline may be defined for the transmission scheme of the STxMP transmissions.

In other embodiments, the switching between single PUSCH STxMP (with SDM or SFN) and two PUSCHs STxMP is not allowed. In such embodiments, the UE may be either RRC configured with SDM (or SFN) or be RRC configured with coresetPoolIndex in ControlResourceSet. The UE may not be configured with both.

Currently, sDCI dynamic switching between mTRP based STxMP configured with SDM (or SFN) and sTRP based PUSCH is allowed. If the DCI bit field “SRS resource set indicator” indicates 00, or 01, the UE falls back to sTRP based transmission where the PUSCH transmission is associated to first or second SRS resource set, respectively.

Embodiments disclosed herein also address switching between sTRP and mTRP PUSCH+PUSCH transmissions, based on the UE's capability to perform SDM (or SFN). In accordance with embodiments disclosed herein, when the UE is configured with two SRS resource sets with the same usage, if the UE is scheduled a PUSCH non-overlapping with another PUSCH and the UE is not configured with SDM (nor SFN), embodiments may assume a sTRP based transmission, where the DCI has single SRI/TPMI bit-field. In such embodiments, the SRI/TPMI bit-field is determined based on the SRS resource set that is associated to the coresetPoolIndex in ControlResourceSet of the PDCCH that schedules the DG-PUSCH, or activates Type2 CG-PUSCH.

In accordance with other embodiments, when the UE is configured with two SRS resource sets with the same usage, if the UE is scheduled a PUSCH non-overlapping with another PUSCH and the UE is configured with SDM (nor SFN), embodiments may be dynamically switched to sTRP based transmission based on “SRS resource set indicator.” The switch may be performed similarly to the embodiments described above with respect to switching between single PUSCH STxMP (with SDM or SFN) to PUSCH+PUSCH STxMP. That is, the UE may be RRC configured with both SDM (or SFN) and a coresetPoolIndex in ControlResourceSet. The transmission may be dynamically switch based on the detection of different ControlResourceSets having different values of coresetPoolIndex from the received DCIs.

In accordance embodiments herein, for mTRP based STxMP PUSCH+PUSCH transmissions when the UE is configured with two SRS resource sets with the same usage, the SRS resource sets may be codebook or non-codebook based. For codebook based, the two SRS resource sets can have a different number of SRS antenna ports per set. For non-codebook based, the two SRS resource sets can have a different number of SRS resources per set.

Embodiments disclosed herein further address power adjustments (or power amplifications) when PUSCHs overlap in the frequency and/or time domains. Although mDCI based STxMP PUSCH+PUSCH transmission supports overlapping of PUSCHs, there is no symbol-level power adjustment within a fully/partially overlapping PUSCH transmission in the time domain.

Currently, the UE determines the PUSCH transmission power in a PUSCH transmission i according to the following equation (see 3GPP TS 38.213, clause 7.1.1).

$${P}_{PUSCH , b , f , c} ( i , j , {q}_{d} , l ) = min \{ \begin{matrix}{P}_{CMAX , f , c} ( i ) , \\ \begin{matrix}{P}_{O\_PUSCH , b , f , c} ( j ) + 10 log \text{?} ( {2}^{μ} \cdot {M}_{RB , b , f , c ,}^{PUSCH} ( i ) ) + \\ {α}_{b , f , c} ( j ) \cdot {PL}_{b , f , c} ( {q}_{d} ) + Δ {\text{?}}_{b , f , c} ( i ) + {f}_{b , f , c} ( i , l )\end{matrix}\end{matrix} \}$$

$$\text{?} \text{indicates text missing or illegible when filed}$$

In this equation, PCMAX is the UE configured maximum transmit power for carrier f of serving cell c in PUSCH occasion i. P₀, alpha, PL, and ClosedLoopIndex, l, represent other considerations that contribute to the power according to current specifications.

In accordance with embodiments disclosed herein, the UE may indicate a capability for power adjustment across all panels or a capability for power adjustment across individual panels.

That is, the UE may indicate the capability of power amplification across both panels in accordance with embodiments. For mTRP based STxMP PUSCH+PUSCH transmissions with the UE configured with PCMAX for STxMP operation, the above equation may be used to determine the transmit powers for each PUSCH. In these embodiments, the SRI field is mapped to the SRI-PUSCH-PowerControlId parameter for the UE to obtain P0, alpha, PL, and ClosedLoopIndex, l, (see 3GPP TS 38.331, IE SRI-PUSCH-PowerControl).

If the sum of the powers determined for each PUSCH is greater than the maximum power available (P_{PUSCH1}+P_{PUSCH2}>P_{CMAX}), embodiments may prioritize one of the PUSCHs for transmission power reduction. The maximum power available may represent a total maximum power constraint across all panels. This prioritization may occur similar to embodiments described above that prioritize PUSCHs in view of a maximum number of layers violation. However, in these embodiments, the lower priority PUSCH may not be necessarily dropped, but may be rescheduled.

In accordance with embodiments disclosed herein, the UE may indicate the capability of separate power amplifications per panel. The indication may include a maximum transmission power P_{M1} and P_{M2} for a two-panel UE. For mTRP based STxMP PUSCH+PUSCH transmissions with the UE configured with P_{CMAX} for STxMP operation, the UE will not expect an operation with P_{M1}+P_{M2}>P_{CMAX}. That is, in some embodiments, the network will not allow a configuration with P_{M1}+P_{M2}>P_{CMAX}.

In accordance with other embodiments, if such a configuration such that P_{M1}+P_{M2}>P_{CMAX} is allowed by the network and the UE capabilities indicate inter-panel dynamic power sharing, the transmission power may be determined relative to a reference PUSCH of the two PUSCHs. The selection of the reference PUSCH is not particularly limited, and may be selected, for example, based on priority or start time. The actual transmit power for the reference PUSCH is determined using the above equation. For example, the actual transmit power for the reference PUSCH may be less than the maximum transmission power for that PUSCH (i.e., if the reference PUSCH is the first panel, P_{actual}≤P_{M1}).

In accordance with embodiments, the UE determines the transmission power for the non-reference PUSCH as the minimum value of the maximum power specified for the panel (P_{M2}) and the different between the total maximum power (P_{CMAX}) and the actual transmit power of the reference PUSCH (P_{actual}). In other words, the transmission power for the non-reference PUSCH is taken as the min(P_{M2}, P_{CMAX}−P_{actual}).

Embodiments disclosed herein also prioritize PUSCH STxMP transmission in carrier aggregation operations. Currently, a PUSCH STxMP transmission would have the same priority order as other UL transmissions in the other component carriers (CCs) during carrier aggregation. In embodiments disclosed herein, the PUSCHs with STxMP transmissions are prioritized over the other UL transmissions in other CCs. For example, if CC0 is a PCell within a cell group, the UE may be scheduled to transmit a first PUSCH₁ (as sTRP) on CC1, and PUSCH₂+PUSCH₃ (as STxMP) on CC2. In embodiments disclosed herein, the STxMP transmission on CC2 has a higher priority than the sTRP transmission on CC1.

Currently, out of order PUSCHs are allowed in mDCI mTRP transmissions. That is, in Release 17, out of order (OoO) PUSCHs were permitted for non-overlapping PUSCHs. This was expanded in Release 18 to include partially overlapping PUSCHs. In accordance with embodiments disclosed herein, for mDCI STxMP PUSCH+PUSCH transmissions, the UE can not be scheduled with OoO PUSCHs when the DCIs indicate the same closed loop index and the UE is not provided transmit power control accumulation (i.e., tpc-Accumulation). Therefore, the UE will not be indicated with OoO PUSCHs in embodiments disclosed herein.

Embodiments disclosed herein establish a processing timeline for overlapping PUSCH+PUSCH transmissions. In embodiments, a time period is defined as the last symbol of the scheduling DCIs until the first symbol of a reference PUSCH of the overlapping PUSCHs is configured to be adjusted.

In these embodiments, the reference PUSCH may be selected based on the priority. That is, the reference PUSCH may be selected because the reference PUSCH is the PUSCH that may have its power reduced if needed.

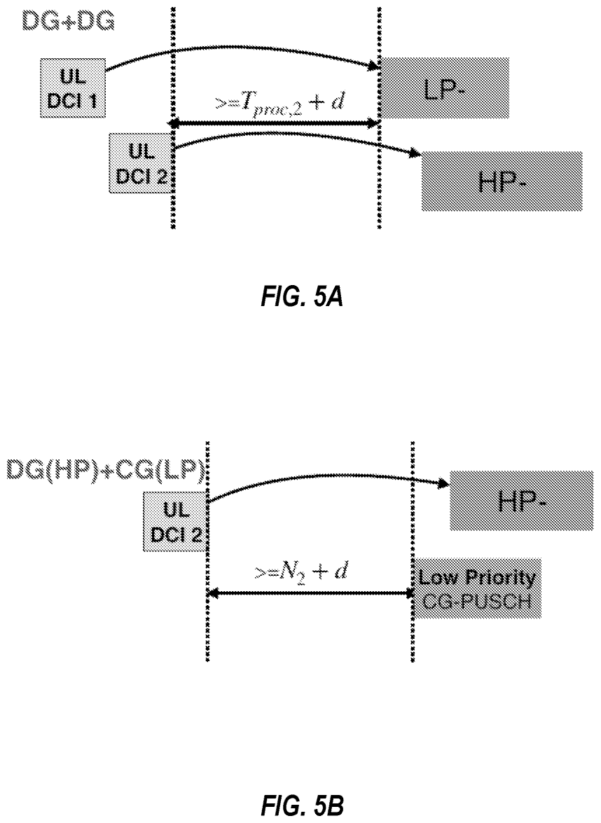

FIGS. 5A and 5B are schematics illustrating a processing timeline for PUSCH+PUSCH transmissions, according to some aspects. For example, as shown in FIG. 5A, for DG-PUSCH+DG-PUSCH transmissions with different priorities, the lower priority DG-PUSCH LP-will selected as the reference PUSCH because its power may be dependent on the higher priority DG-PUSCH HP-. As shown, the processing timeline is modified by adding a number of symbols d to the standard timing, T_{proc,2}.

As shown in FIG. 5B, for DG-PUSCH+CG-PUSCH where the DG-PUSCH HP- has a higher priority than the low priority CG-PUSCH, the CG-PUSCH will be the reference PUSCH. In this example, the number of symbols d are added to the standard timing N2.

In accordance with embodiments disclosed herein, no timeline modifications are needed for DG-PUSCH+DG-PUSCH or DG-PUSCH+CG-PUSCH transmissions with the same priority. Also, no timeline adjustments are needed for DG-PUSCH+CG-PUSCH transmissions where the DG-PUSCH is a lower priority than the CG-PUSCH.

The timelines illustrated in FIGS. 5A and 5B are based on the UE processing capability and minimum of sub-carrier spacing (SCS) between the scheduling DCIs and overlapping PUSCHs. The number of symbols d to modify the timing may depend on the implementation of other embodiments disclosed herein. For example, the number of symbols d may depend on whether switching from sTRP to mTRP (for both DG-PUSCH+DG-PUSCH and CG-PUSCH+DG-PUSCH) is implemented. The number of symbols d may also depend on whether switching between STxMP SDM/SFN and STxMP PUSCH+PUSCH transmission is implemented. The prioritizations of PUSCHs established to determine the transmission power for PUSCH+PUSCH transmissions may also help determine the appropriate number of symbols d.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, anon-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

1. A method for multiple Downlink Control Information (mDCI) Simultaneous Transmission across Multiple Panels (STxMP) transmissions, the method comprising:
transmitting, by a User Equipment (UE) in a UE capability message, at least one maximum number of layers associated with panels of the UE;
receiving a first Downlink Control Information (DCI) comprising a first Control Resource Set (CORESET) pool index from a first Transmission/Reception Point (TRP); and
receiving a second DCI comprising a second CORESET pool index from a second TRP.

2. The method of claim 1, wherein a UE determines there is mDCI communication based on determining that the first DCI is different from the second DCI.

3. The method of claim 1, wherein a UE determines there is mDCI communication based on determining that the first CORESET pool index is different from the second CORESET pool index.

4. The method of claim 1, wherein the maximum number of layers associated with panels of the UE comprises: a value for single TRP transmission and at least one value for multiple TRP transmissions.

5. The method of claim 1, wherein the UE capability indicates a maximum number of layers common to all panels of the UE.

6. The method of claim 1, wherein the maximum number of layers associated with panels of the UE of the UE capability is based on a time overlap of Physical Uplink Shared Channels (PUSCHs).

7. The method of claim 1, wherein the maximum number of layers associated with each panel of the UE capability is based on a time and frequency overlap of Physical Uplink Shared Channels (PUSCHs).

8. The method of claim 1, wherein the maximum number of layers associated with each panel of the UE capability is based on an alignment of Demodulation Reference Symbols (DMRS).

9.-34. (canceled)

35. A User Equipment (UE) comprising:
a transmitter that transmits a UE capability message comprising at least one maximum number of layers associated with panels of the UE;
a receiver that receives a first Downlink Control Information (DCI) comprising a first Control Resource Set (CORESET) pool index from a first Transmission/Reception Point (TRP); and
the receiver receives a second DCI comprising a second CORESET pool index from a second TRP.

36. (canceled)

37. A baseband processor configured to cause a User Equipment (UE) to:
transmit a UE capability message comprising at least one maximum number of layers associated with panels of the UE;
receive a first Downlink Control Information (DCI) comprising a first Control Resource Set (CORESET) pool index from a first Transmission/Reception Point (TRP); and
receive a second DCI comprising a second CORESET pool index from a second TRP.

38. The UE of claim 35, wherein the UE determines there is mDCI communication based on determining that the first DCI is different from the second DCI.

39. The UE of claim 35, wherein the UE determines there is mDCI communication based on determining that the first CORESET pool index is different from the second CORESET pool index.

40. The UE of claim 35, wherein the maximum number of layers associated with panels of the UE comprises: a value for single TRP transmission and at least one value for multiple TRP transmissions.

41. The UE of claim 35, wherein the UE capability indicates a maximum number of layers common to all panels of the UE.

42. The UE of claim 35, wherein the maximum number of layers associated with each panel of the UE capability is based on an alignment of Demodulation Reference Symbols (DMRS).

43. The baseband processor of claim 37, wherein the UE determines there is mDCI communication based on determining that the first DCI is different from the second DCI.

44. The baseband processor of claim 37, wherein the UE determines there is mDCI communication based on determining that the first CORESET pool index is different from the second CORESET pool index.

45. The baseband processor of claim 37, wherein the maximum number of layers associated with panels of the UE comprises: a value for single TRP transmission and at least one value for multiple TRP transmissions.

46. The baseband processor of claim 37, wherein the UE capability indicates a maximum number of layers common to all panels of the UE.

47. The baseband processor of claim 37, wherein the maximum number of layers associated with each panel of the UE capability is based on an alignment of Demodulation Reference Symbols (DMRS).
